(19) United States
(12) Patent Application Publication
(10) Pub. No.: US 2012/0130938 A1
(43) Pub. Date: May 24, 2012

(54) NETWORK STATE PREDICTION DEVICE, MOBILE COMMUNICATION SYSTEM, MOBILE COMMUNICATION METHOD, AND STORAGE MEDIUM

(75) Inventor: Hiroshi Tamano, Tokyo (JP)

(73) Assignee: NEC CORPORATION, Minato-ku, Tokyo (JP)

(21) Appl. No.: 13/386,233

(22) PCT Filed: Jul. 22, 2010
(86) PCT No.: PCT/JP2010/004684

§ 371 Date: Jan. 20, 2012

(30) Foreign Application Priority Data
Jul. 23, 2009 (JP) 2009-172118

(51) Int. Cl. G06N 5/02

(52) U.S. Cl. 706/52

(57) ABSTRACT

A network state prediction device 100 includes: a database unit 120 that stores an end position on one side of a route on which a mobile communication terminal 500 moves, an end position on the other side of the route, and a network state indicative of a communication quality on the route, in a manner that these end positions, and the network state are associated with each other; a prediction target input unit 111 adapted to input an end position on one side of a target route serving as a route to be predicted, and an end position on the other side of the target route; a network state retrieving unit 112 that retrieve the network state on the basis of the inputted position information, and the position information stored in the database unit 120; and a prediction unit 113 that generates network prediction information concerning the communication quality at the time when the mobile communication terminal 500 moves on the target route, on the basis of the retrieved network state.

### TECHNICAL FIELD

The present invention relates to a network state prediction device, a mobile communication system, a mobile communication method, and a storage medium storing a program.

### BACKGROUND ART

Currently, there exist various types of mobile devices that a user can carry around, including a notebook personal computer, a mobile phone, and a personal data assistance (PDA).

As these mobile devices can be carried around, they are not always online to a network, and are offline in some places unlike desktop computers. For example, in general, when used in offices, the notebook computer can be connected to an office wireless LAN to be online, whereas, when outside the office, it is offline unless signing up with a telecommunications carrier. Further, the mobile phone is generally online in a wide area, but it is offline in a limited area such as in a subway.

When used on offline, the mobile device needs to obtain necessary information at the time of online in advance, and store it in a storage device. One example of applications supporting data access at the time of offline as described above includes Gmail, which is a web mail, and AvantGo, which is an application capable of viewing web pages with the mobile devices. In general, these offline-applicable applications themselves do not know when the mobile device will go offline. Therefore, before going offline, these applications obtain data by a user manually clicking an information-obtaining button, or by the application regularly accessing the network and executing a polling to monitor all the time whether or not there exists information that should be obtained. The former requires the user to perform the operation before offline without fail, while the latter is inefficient to require the regular use of the network, which is inefficient.

Therefore, if changes of the network states of the mobile device can be predicted, it is possible to automatically obtain the information in an efficient manner.

As a technique of this kind, Patent Document 1 (Japanese Patent Application Laid-open No. H8-241257) describes the following technique. A prediction result is generated on the basis of first knowledge indicating an action schedule of a specific user, and second knowledge indicating a relationship between an action of the user and a property of information that can be provided to the user. Then, the information is distributed on the basis of the generated prediction result. The prediction result includes a position of a user terminal, an action (operation) of the user, a possibility that the action is actually implemented, information or application software in connection with the action, a status of connection between the user terminal and a network environment, in each time period.

As a technique having a type different from the above-described technique, Patent Document 2 (Japanese Patent Application Laid-open No. 2005-130294) describes the following technique. Communication information of a mobile phone is stored. On the basis of the stored communication information, a probability of existence of the mobile phone in each position, and a probability of contents being distributed to the mobile phone for each type are calculated. On the basis of the calculated probabilities, the content is distributed to the mobile phone. Here, the stored communication information includes a time when the communication starts, the time when the communication ends, types of network to which the mobile phone communicatively connects, and positions at which the communication is performed.

### RELATED DOCUMENT

### Patent Document

Patent Document 1: Japanese Patent Application Laid-open No. H8-241257
Patent Document 2: Japanese Patent Application Laid-open No. 2005-130294

### SUMMARY OF THE INVENTION

However, these techniques have rooms for improvement in the following points. The technique described in Patent Document 1 determines whether or not the predicted position of the user terminal is located in the communication-possible area to predict the status of connection between the user terminal and the network environment. With this prediction method, it cannot be deemed that it is actually determined whether or not the user terminal can communicate. This is because, even if the user terminal is located in the communication-possible area as the network environment, there is a possibility that, in the above-described area, there exists a local area where shielding objects or the like prevents the communication between the user terminal and a wireless base station.

Further, even if the mobile phone is located in the communication-possible area, the technique described in Patent Document 2 cannot accumulate the communication information without accessing the network. Therefore, there is a possibility that the prediction accuracy decreases when determination is made on the basis of this communication information as to whether or not the mobile phone can communicate with the network.

The present invention has been made in view of the circumstances described above, and an object of the present invention is to provide a network state prediction device, a mobile communication system, a mobile communication method, and a storage medium storing a program, capable of accurately predicting a quality of communication of a mobile communication terminal.

According to the present invention, there is provided a network state prediction device including: a database unit that stores first position information indicative of an end position on one side of a route on which a mobile communication terminal moves, second position information indicative of an end position on the other side of the route, and a network state indicative of a communication quality of a line to which the mobile communication terminal communicatively connects on the route, in a manner that the first position information, the second position information, and the network state are associated with each other; a prediction target input unit adapted to input first input position information indicative of an end position on one side of a target route serving as a route to be predicted, and second input position information indicative of an end position on the other side of the target route; a network state retrieving unit that retrieve the network state from the database unit on the basis of the first input position information and the second input position information, both of which are inputted through the prediction target input unit, and the first position information and the second position information, both of which are stored in the database unit; and a prediction unit that generates network prediction information concerning the communication quality at the time when the mobile communication terminal moves on the target route, on the basis of the network state retrieved by the network state retrieving unit.

Further, according to the present invention, there is provided a mobile communication system including: a mobile communication terminal; a transmission-and-reception device that transmits and receives electronic data in response to a request received from the mobile communication terminal; and a network state prediction device that outputs, to the mobile communication terminal, network prediction information concerning a communication quality at the time when the mobile communication terminal moves on a target route, which is a route to be predicted, the network state prediction device including: a database unit that stores first position information indicative of an end position on one side of a route on which the mobile communication terminal moves; a prediction target input unit adapted to input first input position information indicative of an end position on one side of the target route, and second input position information indicative of an end position of the other side of the target route; a network state retrieving unit that retrieves the network state from the database unit on the basis of the first input position information and the second input position information, both of which are inputted through the prediction target input unit, and the first position information and the second position information, both of which are stored in the database unit; and a prediction unit that generates the network prediction information on the basis of the network state retrieved by the network state retrieving unit, and the mobile communication terminal requesting the transmission-and-reception device to transmit and receive the electronic data on the basis of the network prediction information received from the network state prediction device.

Yet further, according to the present invention, there is provided a mobile communication method including: a database generating step of generating a database by storing first position information indicative of an end position on one side of a route on which a mobile communication terminal moves, second position information indicative of an end position on the other side of the route, and a network state indicative of a communication quality of a line to which the mobile communication terminal communicatively connects on the route in a manner that the first position information, the second position information, and the network state are associated with each other; a prediction target input step of inputting first input position information indicative of an end position on one side of a target route, which is a route to be predicted, and second input position information indicative of an end position on the other side of the target route; a network state retrieving step of retrieving the network state from the database on the basis of the first input position information and the second input position information, both of which are inputted in the prediction target input step, and the first position information and the second position information, both of which are stored in the database; a prediction step of generating network prediction information concerning the communication quality at the time when the mobile communication terminal moves on the target route, on the basis of the network state retrieved in the network state retrieving step; and a request step of making a request, by the mobile communication terminal, to transmit and receive electronic data on the basis of the network prediction information generated in the prediction step.

Yet further, according to the present invention, there is provided a storage medium storing a program that causes a network state prediction device to execute data processing, the data processing including: a database generating process of generating a database by storing first position information indicative of an end position on one side of a route on which a mobile communication terminal moves, second position information indicative of an end position on the other side of the route, and a network state indicative of a communication quality of a line to which the mobile communication terminal communicatively connects on the route, in a manner that the first position information, the second position information, and the network state are associated with each other; a prediction target input process of inputting first input position information indicative of an end position on one side of a target route, which is a route to be predicted, and second input position information indicative of an end position on the other side of the target route; a network state retrieving process of retrieving the network state from the database on the basis of the first input position information and the second input position information, both of which are inputted in the prediction target input process, and the first position information and the second position information, both of which are stored in the database; and a prediction process of generating network prediction information concerning the communication quality at the time when the mobile communication terminal moves on the target route, on the basis of the network state retrieved in the network state retrieving process.

According to the present invention, there is provided a network state prediction device, a mobile communication system, a mobile communication method, and a storage medium storing a program, which accurately predict a communication quality of a mobile communication terminal.

### BRIEF DESCRIPTION OF THE DRAWINGS

The above-described object and other objects of the present invention, and features and advantages of the present invention will be made further clear by the preferred exemplary embodiment described below and the following attached drawings.

FIG. 1 is a configuration diagram illustrating a mobile communication system according to a first exemplary embodiment of the present invention.

FIG. 2 is a diagram illustrating a route on which a mobile communication terminal moves, a starting position of the route, and an ending position of the route.

FIG. 3 is a diagram illustrating a part of a data table in a database unit according to the first exemplary embodiment.

FIG. 4 is a flowchart illustrating a method for predicting a network state employing the network state prediction device according to this exemplary embodiment.

FIG. 5 is a configuration diagram illustrating a mobile communication system according to a second exemplary embodiment of the present invention.

FIG. 6 is a diagram illustrating a part of a data table in a database unit of the second exemplary embodiment.

FIG. 7 is a flowchart illustrating a method for predicting a network state employing a network state prediction device according to the second exemplary embodiment.

FIG. 8 is a diagram visually illustrating generation of network prediction information by a prediction unit according to the second exemplary embodiment.

FIG. 9 is a diagram illustrating a prediction result according to the second exemplary embodiment using a graph.

FIG. 10 is a configuration diagram illustrating a mobile communication system according to a third exemplary embodiment of the present invention.

FIG. 11 is a diagram illustrating a part of a data table in a schedule database unit according to the third exemplary embodiment.

FIG. 12 is a diagram illustrating a part of a data table in a network database unit according to the third exemplary embodiment.

### DESCRIPTION OF EMBODIMENTS

Hereinbelow, an exemplary embodiment of the present invention will be described with reference to the drawings. Note that, in all the drawings, the same constituent components are denoted with the same reference numerals, and detailed explanation thereof will not be repeated.

### First Exemplary Embodiment

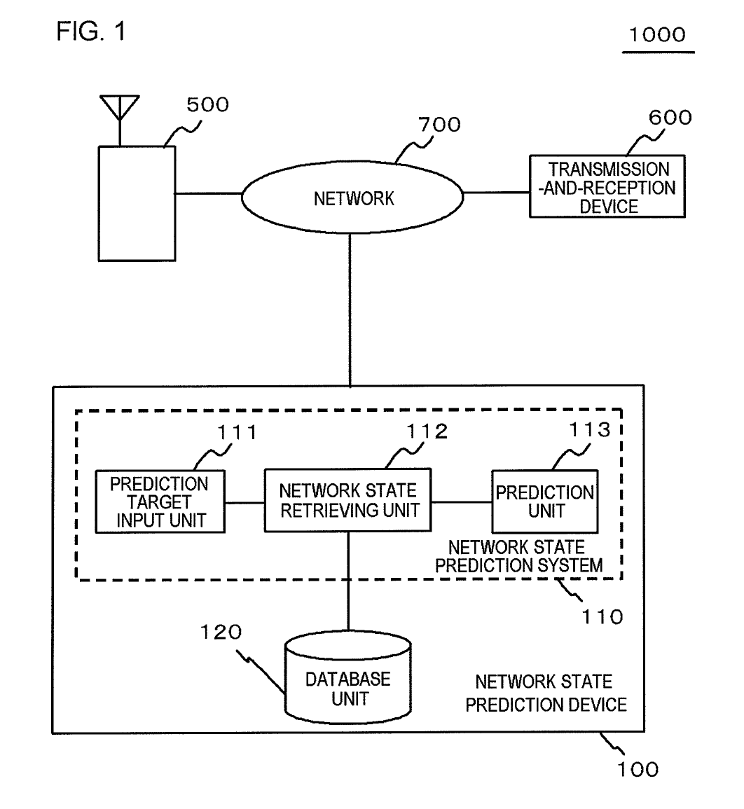

FIG. 1 is a configuration diagram illustrating a mobile communication system 1000 according to a first exemplary embodiment. In the mobile communication system 1000, a network state prediction device 100, a mobile communication terminal 500, and a transmission-and-reception device 600 are connected through a network 700.

The mobile communication terminal 500 may be a mobile phone, or may be a personal handy-phone system (PHS), or may be a mobile personal computer or game device. Further, in FIG. 1, the mobile communication terminal 500 and the network 700 are connected through a wireless connection.

The transmission-and-reception device 600 transmits and receives electronic data in response to a request from the mobile communication terminal 500. For example, the transmission-and-reception device 600 may be an electronic mail server that transmits an electronic mail to the mobile communication terminal 500 in response to the request from the mobile communication terminal 500. Further, the transmission-and-reception device 600 may be a web mail server that transmits a web mail stored in the transmission-and-reception device 600 in response to the request from the mobile communication terminal 500 in a data format in which the mobile communication terminal 500 can display and output. Yet further, the transmission-and-reception device 600 may be a network storage that transmits a data file stored in the transmission-and-reception device 600 in response to a request from the mobile communication terminal 500, or stores a data file from the mobile communication terminal 500.

The network 700 may be the Internet, or may be a LAN. Further, the network 700 may contain one or more devices that are not illustrated in FIG. 1.

A network state prediction device 100 outputs, to the mobile communication terminal 500, network prediction information concerning a quality of communication at the time when the mobile communication terminal 500 moves on a target route, which is a route to be predicted. Next, the network state prediction device 100 will be described in more detail.

The network state prediction device 100 includes a database unit 120 that stores first position information indicative of an end position on one side of a route on which the mobile communication terminal 500 moves, second position information indicative of an end position on the other side of the route, and a network state indicative of a quality of communication of a line to which the mobile communication terminal 500 communicatively connects on the route, in a manner that the first position information, the second position information, and the network state are associated with each other. The network state prediction device 100 further includes a prediction target input unit 111 for inputting the first position information and the second position information. The network state prediction device 100 further includes a network state retrieving unit 112 that retrieves from the database unit 120 a network state associated with the first position information and the second position information inputted through the prediction target input unit 111. The network state prediction device 100 further includes a prediction unit 113 that generates network prediction information concerning the quality of communication at the time when the mobile communication terminal 500 moves on the target route, on the basis of the network state retrieved by the network state retrieving unit 112. The prediction target input unit 111, the network state retrieving unit 112, and the prediction unit 113 constitutes a network state prediction system 110.

It should be noted that the term “end position” that the first position information, the second position information, first input position information, and second input position information indicate may be a zone having a certain length or a certain dimension.

All or part of the configuration contained in the network state prediction device 100 may be realized by hardware, or may be realized by a program (or program code) that causes a processor (not illustrated) of the network state prediction device 100 to process. In the case where the configuration contained in the network state prediction device 100 is realized by the program, this program is stored in a not-illustrated storage medium from which a processor (computer) can read out. The program causes the processor to perform a database generation process of generating a database by storing the first position information indicative of the end position on the one side of the route on which the mobile communication terminal moves, the second position information indicative of the end position on the other side of the route, and the network state indicative of the quality of communication of the line to which the mobile communication terminal communicatively connects on the route in a manner that the first position information, the second position information, and the network state are associated with each other. Further, the program causes the processor to perform a prediction target input process of inputting the first input position information indicative of the end position on the one side of the target route, which is the target route to be predicted, and the second input position information indicative of the end position on the other side of the target route. Yet further, the program causes the processor to perform a network state retrieving process of retrieving the network state from the database on the basis of the first input position information and the second input position information inputted through the prediction target input process, and the first position information and the second position information stored in the database. Yet further, the program causes the processor to perform a prediction process of generating network prediction information concerning the quality of communication at the time when the mobile communication terminal moves on the target route, on the basis of the network state retrieved in the network state retrieving process.

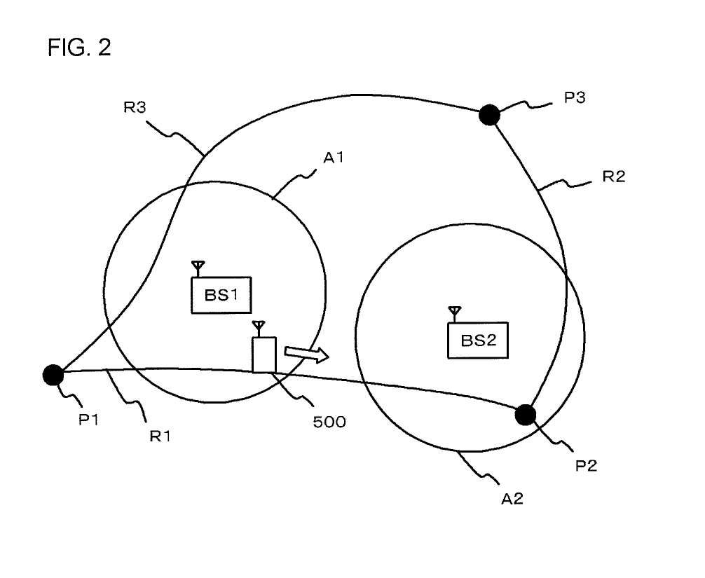

FIG. 2 is a diagram illustrating a route on which the mobile communication terminal 500 moves, a starting position of the route, and an ending position of the route. A route R1 connects P1 and P2. A route R2 connects P2 and P3. A route R3 connects P3 and P1. The route R1, the route R2, or the route R3 passes through an area A1 where wireless communication with a wireless base station BS1 is possible, or an area A2 where wireless communication with a wireless base station BS2 is possible. In FIG. 2, the mobile communication terminal 500 moves on the route R1 in a direction of the arrow with the P1 being the starting position and the P2 being the ending position.

It should be noted that the wireless base station BS1 and the wireless base station BS2 are devices included in the network 700 in FIG. 1.

Next, a description will be made of operations of the mobile communication terminal 500 at the time when the mobile communication terminal 500 moves on the route R1, the route R2, or the route R3 illustrated in FIG. 2. The mobile communication terminal 500 has an obtaining function of obtaining a line speed of the line to which the mobile communication terminal 500 itself communicatively connects. This obtaining function may be a function of obtaining a line speed measured in the mobile communication terminal 500, or may be a function of obtaining a line speed measured by the other device from the other device, the line speed of the line to which the mobile communication terminal 500 connects. It should be noted that this obtaining function may obtain the line speed at periodic intervals, or may obtain the line speed at random. Further, the time intervals may be fixed to a default value, or may be changeable as needed. Further, the obtaining function is desired to be always activated when the mobile communication terminal 500 runs.

The mobile communication terminal 500 has a storing function of storing the line speed obtained with the obtaining function in the database unit 120 as the network state. As a method for realizing this storing function, it may be possible, for example, to employ a method in which the mobile communication terminal 500 and the network state prediction device 100 are connected to each other all the time, and the mobile communication terminal 500 stores the obtained line speed in the database unit 120 every time when the line speed is obtained with the obtaining function. As another method for realizing the storing function, it may be possible to employ a method in which the mobile communication terminal 500 stores the line speed obtained with the obtaining function in a not-illustrated storage medium of the mobile communication terminal 500 itself, and the line speed stored in the storage medium is stored in the database unit 120 at the time when the mobile communication terminal 500 is connected to the network state prediction device 100.

Further, the mobile communication terminal 500 has a route registering function of associating the network state stored by the storing function with the first position information indicative of the starting position of the route on which the network state is obtained, and the second position information indicative of the ending position of this route, and storing the associated information in the database unit 120. As a method for realizing this route registering function, it may be possible, for example, to employ a method of causing a user who uses the mobile communication terminal 500 to input the first position information at the time of activation of the obtaining function, registering the inputted first position information, causing the user to input the second position information at the time of stopping the obtaining function, and registering the inputted second position information. As another method, it may be possible to employ a method of, by utilizing a positioning system such as the Global Positioning System (GPS), registering position information of the mobile communication terminal 500 obtained at the time of activation of the obtaining function as the first position information, and registering position information of the mobile communication terminal 500 obtained at the time when the obtaining function terminates as the second position information.

After the mobile communication terminal 500 moves on the route R1, the route R2, or the route R3, a data table is generated in the database unit 120 by the obtaining function, the storing function, and the route registering function.

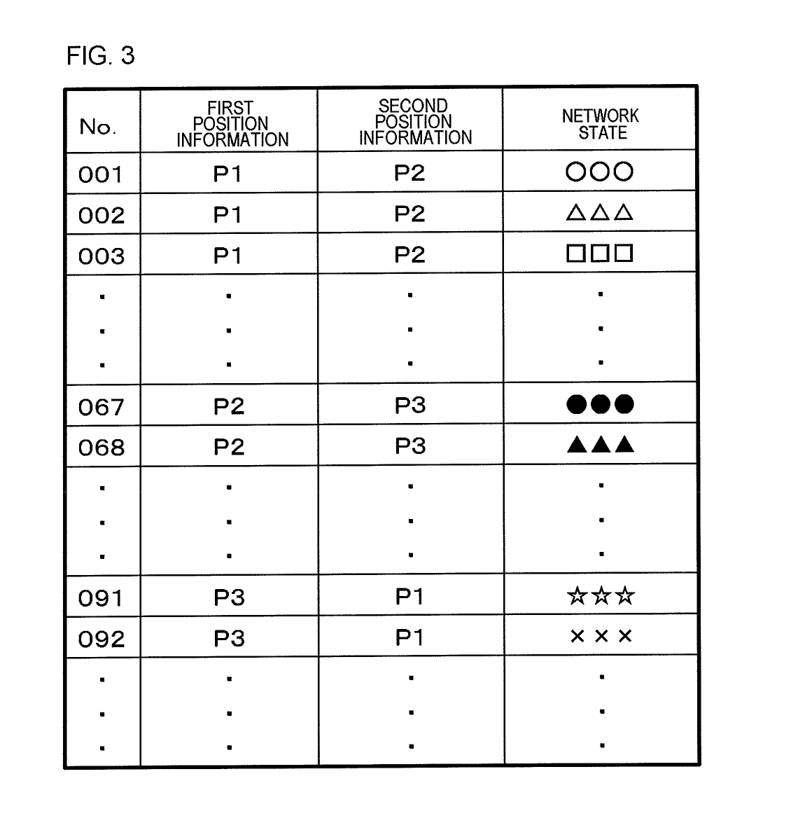

FIG. 3 is a diagram illustrating a part of the data table in the database unit 120 according to this exemplary embodiment. Each line of the data table contains the network state obtained by the mobile communication terminal 500 at a certain point in time, the first position information and the second position information concerning the route on which the mobile communication terminal 500 is located at the time when obtaining the network state, in a manner that the network state, the first position information, and the second position information are associated with each other. The network states obtained by the mobile communication terminal 500 at different points in time are stored in different lines. For example, the line of No. 001 contains the first position information indicative of P1, the second position information indicative of P2, and the network state indicating the line speed of the mobile communication terminal 500 on the R1 from the P1 to the P2. It should be noted that, actually, specific values indicating the line speed are placed for “ooo,” “ΔΔΔ” and the like shown in the column of the network state in FIG. 3.

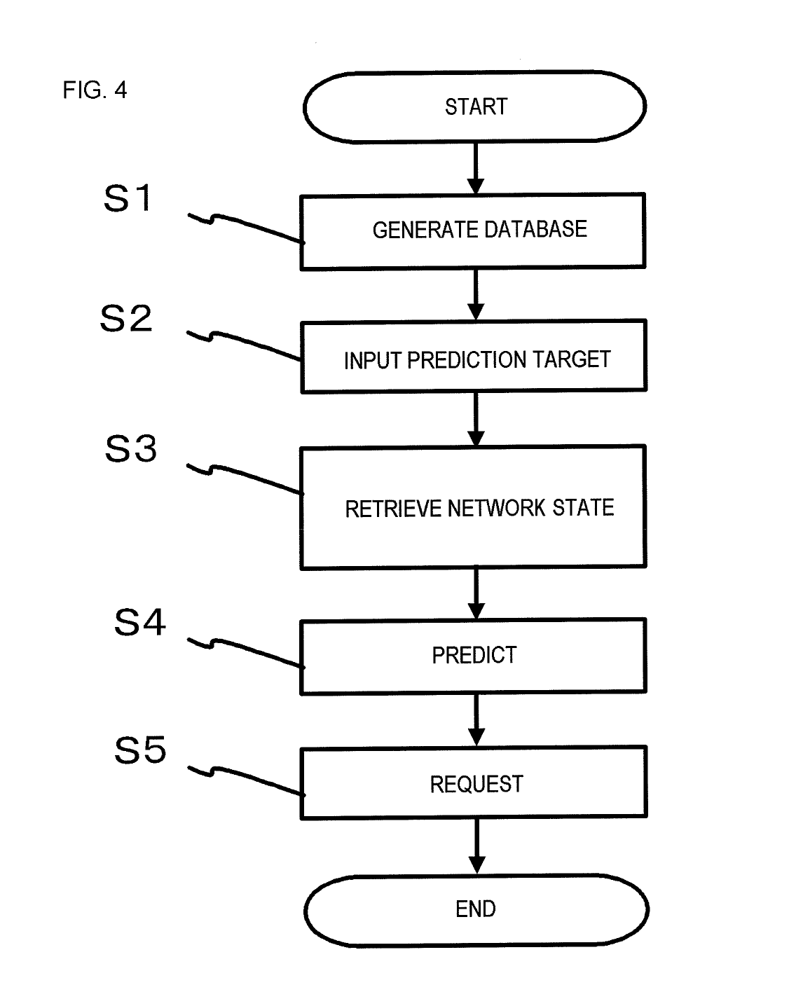

FIG. 4 is a flowchart illustrating a method for predicting a network state employing the network state prediction device 100 according to this exemplary embodiment. Next, with reference to FIG. 4, a description will be made of a method for predicting the network state using the network state prediction device 100 that stores the data table illustrated in FIG. 3.

The network state prediction device 100 stores the first position information indicating the starting position of the route, the second position information indicating the ending position of the route, and the network state indicating the communication quality of a wireless signal received by the mobile communication terminal on the route in a manner that the first position information, the second position information, and the network state are associated with each other, and generates the database in the database unit 120 (step S1). Details of step S1 has been already described above, and thus, explanation thereof will not be repeated.

Next, the network state prediction device 100 (prediction target input unit 111) inputs the first input position information indicating the end position on the one side of the target route, and the second input position information indicating the end position on the other side of the target route (step S2). More specifically, the network state prediction device 100 requests the user who uses the network state prediction device 100 to input the first input position information and the second input position information. Here, it is assumed that, in response to the request, the user inputs information indicative of P1 as the first input position information, and information indicative of P2 as the second input position information. Note that the network state prediction device 100 may include, for example, a keyboard or touch panel (not illustrated) for receiving the input of the first input position information and the second input position information.

Next, the network state prediction device 100 (network state retrieving unit 112) retrieves the network state from the database unit 120 on the basis of the first input position information and the second input position information inputted in step S2, and the first position information and the second position information stored in the database unit 120 (step S3). More specifically, the network state prediction device 100 uses, as keys, the first input position information=P1 and the second input position information=P2 inputted in step S2 to retrieve the network state associated with the first position information=P1 and the second position information=P2 (network states of No. 001, No. 002, and No. 003 in the database in FIG. 3).

In the above description, the first input position information and the second input position information are completely matched with the first position information and the second position information, respectively. However, it may be possible that the network state retrieving unit 112 does not perform the perfect matching. For example, the network state retrieving unit 112 may retrieve the network state associated with the first position information and the second position information in the case where the target route indicated by the first input position information and the second input position information contains a route indicated by the first position information and the second position information.

The network state prediction device 100 (prediction unit 113) generates the network prediction information on the basis of the network state retrieved in step S3 (step S4). More specifically, the network state prediction device 100 collects the network states retrieved in step S3, generates network prediction information indicative of “favorable” in the case where the average value of the collected network states exceeds a threshold value, and generates network prediction information indicative of “poor” in the case where the average value is less than the threshold value. Note that the threshold value is a predetermined value, and may be a fixed value set as a default, or may be a value changeable by the user depending on application.

The mobile communication terminal 500 requests the transmission-and-reception device 600 to transmit and receive electronic data on the basis of the network prediction information from the network state prediction device 100 (step S5). More specifically, the mobile communication terminal 500 requests the transmission-and-reception device 600 to transmit and receive the electronic data in the case where the received network prediction information indicates “favorable.”

Next, effects of this exemplary embodiment will be described. The network state prediction device 100 according to this exemplary embodiment uses, as keys, the inputted first input position information and the inputted second input position information to retrieve, from the database, the network state obtained by the mobile communication terminal 500 on the route, so that the network state prediction device 100 can predict the network state on the route on the basis of the retrieved communication quality. In other words, the prediction is made on the basis of a history of the communication quality of the wireless signal received on the mobile terminal side, whereby prediction accuracy improves as compared with the prediction method in which the prediction is made on the assumption that communication is possible throughout the entire area where the network environment is provided (area A1 or area A2 in FIG. 2).

Further, as the network state, this exemplary embodiment employs the line speed of the line to which the mobile communication terminal 500 is connected. Therefore, the network states can be accumulated in the database as long as the obtaining function is activated.

Further, in this exemplary embodiment, the mobile communication terminal 500 requests the transmission-and-reception device 600 to transmit and receive the electronic data in the case where the received network prediction information indicates “favorable.” Therefore, when the communication quality of the mobile communication terminal 500 is favorable, it is possible to transmit and receive the electronic data between the mobile communication terminal 500 and the transmission-and-reception device 600.

### Second Exemplary Embodiment

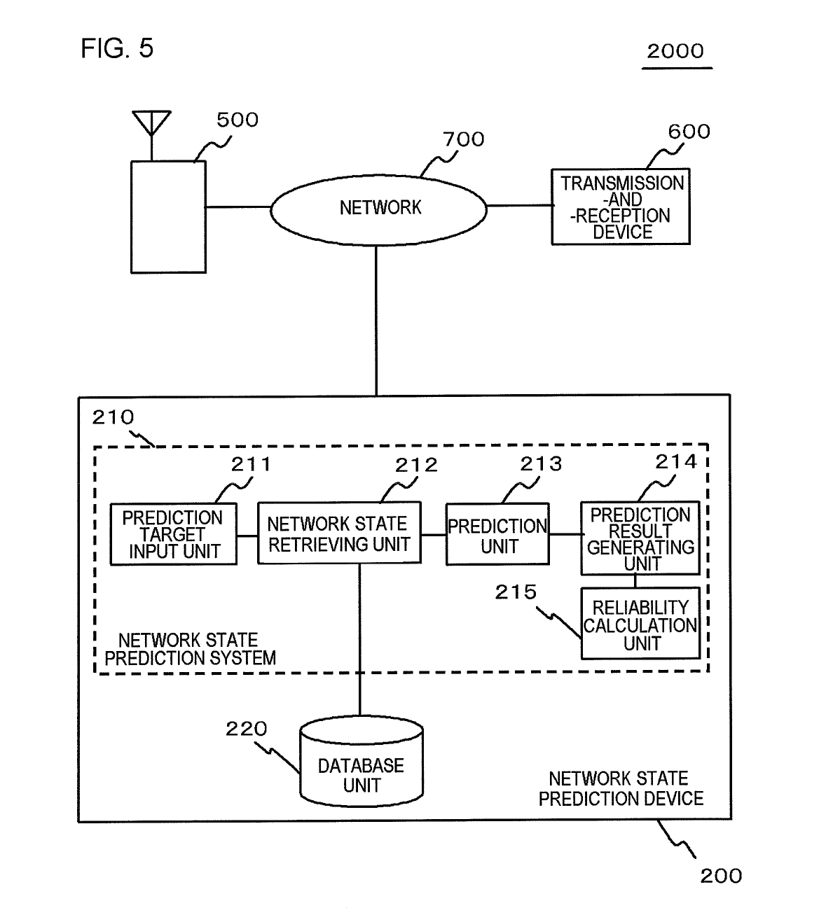

FIG. 5 is a configuration diagram illustrating a mobile communication system 2000 according to a second exemplary embodiment of the present invention. The mobile communication system 2000 according to this exemplary embodiment includes a network state prediction device 200, a mobile communication terminal 500, a transmission-and-reception device 600, and, a network 700. The mobile communication terminal 500, the transmission-and-reception device 600, and the network 700 are equivalent to those described in the first exemplary embodiment.

The network state prediction device 200 includes a configuration contained in a network state prediction system 210, and a database unit 220. The network state prediction system 210 includes a prediction target input unit 211, a network state retrieving unit 212, a prediction unit 213, a prediction result generating unit 214, and a reliability calculation unit 215.

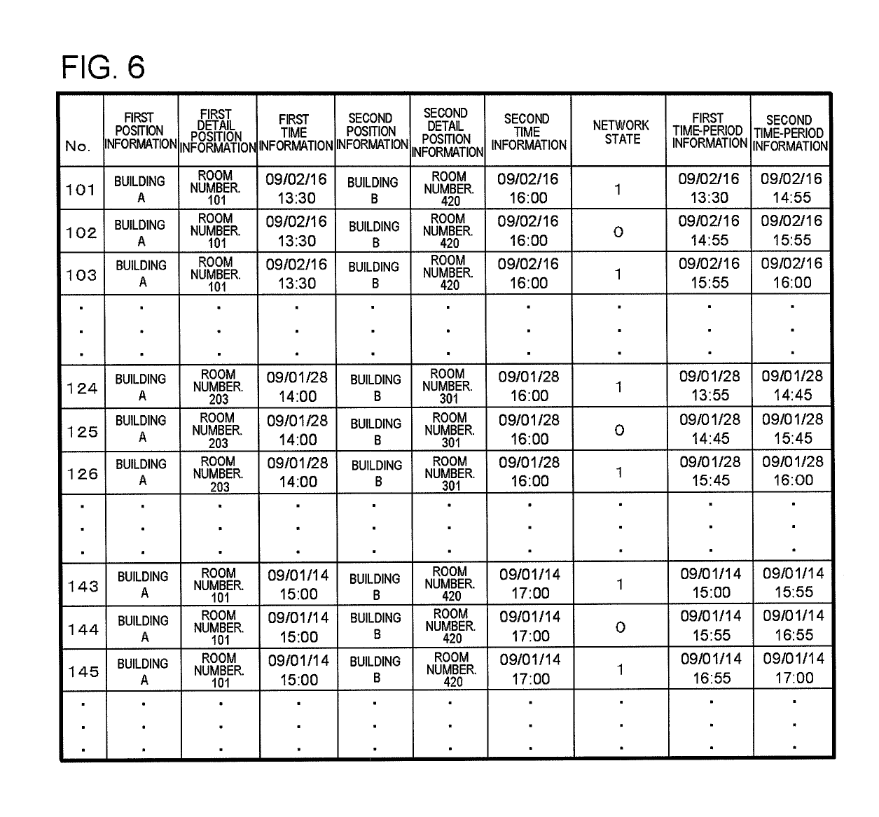

FIG. 6 is a diagram illustrating a part of a data table in the database unit 220 of this exemplary embodiment. Each line of this data table contains first position information, first detail position information, first time information, second position information, second detail position information, second time information, a network state, and time-period information in a manner that they are associated with each other. Note that the first time information is information indicating a time associated with the first position information, and the second time information is information indicating a time associated with the second position information.

The data table contains first time-period information indicating a starting time of a certain time period, second time-period information indicating an ending time of the certain time period, and a network state indicating a communication quality of the mobile communication terminal 500 at the certain time period in a manner that they are associated with each other.

The data table stores the first detail position information indicating an area narrower than the area that the first position information indicates, the second detail position information indicating an area narrower than the area that the second position information indicates, in a manner that they are associated with the network state. For example, “Room No. 101” indicated in the first detail position information exists in “Building A” indicated in the first position information of No. 101, and “Room No. 420” indicated in the second detail position information exists in “Building B” indicated in the second position information.

Further, in this data table, the network state is a numeral “1” in the case where the communication quality of the mobile communication terminal 500 is favorable, and is a numeral “0” in the case where the communication quality of the mobile communication terminal 500 is poor. More specifically, the mobile communication terminal 500 obtains a line speed of a line to which the mobile communication terminal 500 connects, through the obtaining method described in the first exemplary embodiment. If the obtained line speed exceeds a predetermined threshold value, the mobile communication terminal 500 generates the network state with a value being “1.” If the obtained line speed is less than the predetermined threshold value, the mobile communication terminal 500 generates the network state with a value being “0.”

While generating the network state as described above, the mobile communication terminal 500 generates time information indicating a time when this network state is generated. Then, as the first time-period information, the mobile communication terminal 500 stores, in the database unit 220, time information concerning the point in time when the network state changes, in a manner that the time information is associated with this network state. Further, as the second time-period information, the mobile communication terminal 500 stores time information immediately before the network state changes to the next state, in a manner that the time information is associated with the network state immediately before this network state change. Note that the above-described time information may be information indicating a time when the mobile communication terminal 500 obtains the line speed. As described above, the time-period information and the network information are stored in the database unit 220.

It should be noted that, in this data table, the first time-period information or second time-period information may indicate the time same as the associated first time information or second time information, or may indicate the time different from the associated first time information or second time information.

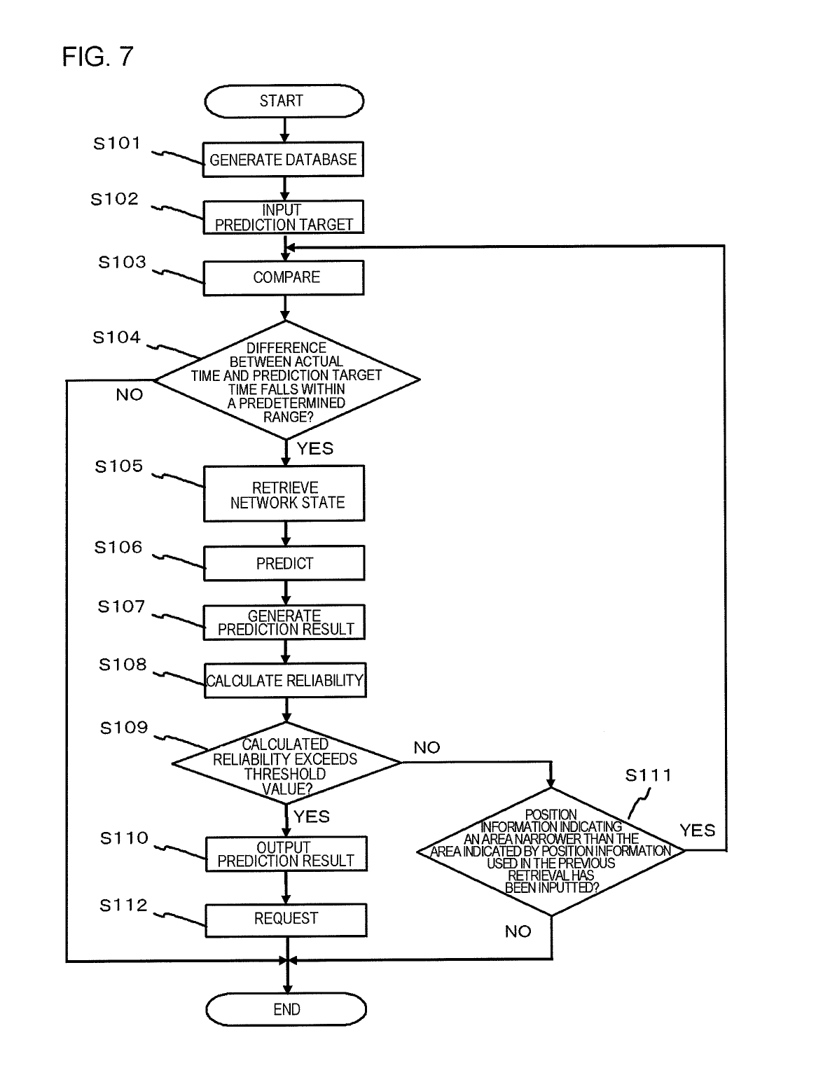

FIG. 7 is a flowchart illustrating a method for predicting a network state employing the network state prediction device 200 according to this exemplary embodiment. Here, with reference to FIG. 7, a description will be made of the method for predicting the network state using the network state prediction device 200 that stores the data table illustrated in FIG. 6.

The network state prediction device 200 generates a database in the database unit 220 (step S101). Details of step S101 has been already described above, and thus, explanation thereof will not be repeated.

The prediction target input unit 211 is a unit for inputting the first input position information and the second input position information, and further for inputting first detail input position information indicating an area narrower than the area that the first input position information indicates, and second detail input position information indicating an area narrower than the area that the second input position information indicates. Further, the prediction target input unit 211 is a unit for inputting first input time information indicating a time associated with the first position information, and second input time information indicating a time associated with the second position information. (step S102). Here, a description will be made on the assumption that the first input position information=Building A, the first detail input position information=Room No. 101, the first input time information=14:00, the second input position information=Building B, the second detail input position information=Room No. 420, and the second input time information=16:00 are inputted through the prediction target input unit 211.

The network state retrieving unit 212 compares time T1 (actual time) extending from the first time information to the second time information, those information are associated with a certain network state of the network states associated with the first position information and the second position information matching with the inputted first input position information and the inputted second input position information, with time T2 (prediction target time) extending from the first input time information to the second input time information, those information are inputted through the prediction target input unit 211 (step S103). If the difference between these times falls in a predetermined range (YES in step S104), retrieval of this network state is performed (step S105). In this exemplary embodiment, the above-described range is set to plus 30 minutes. As a result of this retrieval, the network states of No. 101 to No. 103, No. 124 to No. 126, No. 143 to No. 145, and the like as illustrated in FIG. 6 can be retrieved.

It should be noted that, if, in the database unit 220, there exists no network state satisfying that the difference between the time T1 (actual time) and the time T2 (prediction target time) falls within the predetermined range (NO in step S104), the network state prediction device 200 according to this exemplary embodiment cannot generate the network prediction information, and the flowchart ends.

The prediction unit 213 collects the network states retrieved by the network state retrieving unit 212, and values obtained by normalizing the collected network states are generated as the network prediction information (step S106).

The prediction result generating unit 214 generates a prediction result in which plural pieces of the network prediction information generated by the prediction unit 213 are integrated (step S107).

The reliability calculation unit 215 calculates a reliability of the prediction result generated by the prediction result generating unit 214 (step S108). If the reliability obtained by the reliability calculation unit 215 in step S108 exceeds a predetermined threshold value (YES in step S109), the prediction result generating unit 214 outputs the prediction result (step S110). Note that the threshold value may be a fixed value set as a default, or may be a value changeable by the user depending on application.

The mobile communication terminal 500 receives the prediction result outputted in step S110, and requests the transmission-and-reception device 600 to transmit and receive electronic data during the time period when the network prediction information contained in this prediction result is favorable (step S112). More specifically, the mobile communication terminal 500 requests the transmission-and-reception device 600 to transmit and receive the electronic data during the time period when a probability of the communication quality being favorable exceeds the predetermined threshold value, or during the time period when a probability of the communication quality being poor is less than the predetermined threshold value.

Further, if the reliability calculated by the reliability calculation unit 215 in step S108 is less than or equal to the threshold value (NO in step S109), the network state retrieving unit 212 proceeds to step S103 since the first detail input position information and the second detail input position information have been already inputted, both of the first detail input position information and the second detail input position information indicating the area narrower than the area of the first input position information and the second input position information used in the retrieving in the last time (YES in step S111). Then, the network state is retrieved from the database unit 220 on the basis of the first detail input position information and the second detail input position information. More specifically, the network state retrieving unit 212 compares time T3 (actual time) extending from the first time information to the second time information, those information are associated with the network state, with time T4 (prediction target time) extending from the first detail position information to the second detail position information, those information are inputted through the prediction target input unit 211 (step S103). If the difference falls in a predetermined range (YES in step S104), retrieval of this network state is performed (step S105).

If a calculated reliability of the prediction result generated on the basis of the first detail input time information and the second detail input time information is less than or equal to the threshold value (NO in step S109), the network state prediction device 200 cannot output the prediction result since position information indicating the area narrower than the areas indicated by the first detail input position information and the second detail input position information is not inputted in this exemplary embodiment (NO in step S111), whereby this flowchart ends.

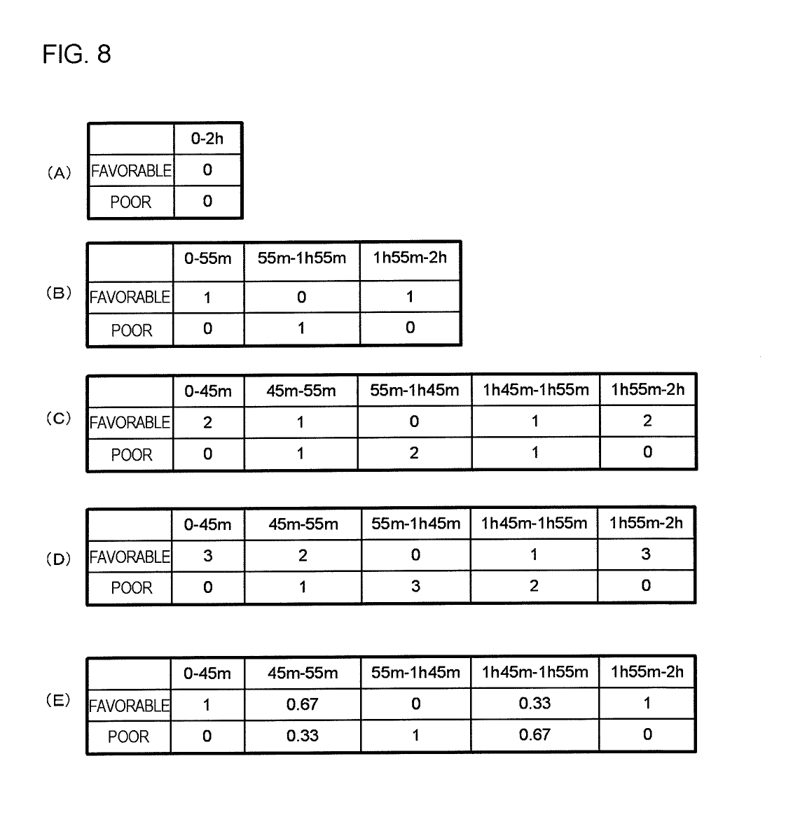

Next, processes of the prediction unit 213 and the prediction result generating unit 214 (step S106 and step S107) will be described specifically. FIG. 8 is a diagram visually illustrating generation of network prediction information by the prediction unit 213. First, the prediction unit 213 generates an initial table as illustrated in FIG. 8(A). Lines of the table represent whether the network state is favorable or poor, and time period (0-2 h) of the prediction target is inputted in columns of the table. Then, all the values are initialized to zero.

Next, the network states retrieved by the network state retrieving unit 212, and the time-period information associated with the respective network states are sequentially inputted in the table of FIG. 8(A). For example, the prediction unit 213 refers to the retrieved No. 101, puts the numeral “1” in the column of favorable since the network state in 0-55 m is “1”, and puts the numeral “0” in the column of poor. In No. 101 to No. 103, although the network state is “1” during 1 hour 25 minutes from the time indicated in the first time-period information, the sum total of the times indicated by the time-period information in No. 101 to No. 103 are 2.5 hours. Therefore, the network state in the first 30 minutes is ignored. Further, by referring to the retrieved No. 102, the numeral “0” is put in the column of favorable, and the numeral “1” is put in the column of poor, since the network state during time between 55 minutes and 1 hour 55 minutes is “0”. By putting the network states and the time-period information of No. 101 to No. 103 in the table of FIG. 8(A) as described above, the table in FIG. 8(B) can be obtained. In a similar manner, by putting the network states and the time-period information of No. 124 to No. 126 in the table of FIG. 8(B), the table in FIG. 8(C) can be obtained. Further, by putting the network states and the time-period information of No. 143 to No. 145 in the table of FIG. 8(C), the table in FIG. (D) can be obtained.

Finally, each of the values in the table is normalized. In other words, the network states collected on the time-period basis are normalized to obtain the normalized values. As a result, FIG. 8(E) can be obtained. Each value in FIG. 8(E) represents the network prediction information according to this exemplary embodiment. As can be clearly understood from the processes described above, each of these pieces of the network prediction information indicates either a probability (online probability) in which the communication quality (line speed) of the mobile communication terminal 500 is favorable in the case where the mobile communication terminal 500 moves on a route from Building A to Building B in two hours, or a probability (offline probability) in which the communication quality is poor. Further, the network prediction information is generated by the prediction unit 213 for each time period defined on the basis of the time-period information.

It should be noted that, in this exemplary embodiment, the above-described processes are employed, by denoting the network state stored in the database unit 220 by “1” in the case where the communication quality of the mobile communication terminal 500 is favorable, and by “0” in the case where the communication quality of the mobile communication terminal 500 is poor. However, this exemplary embodiment is not limited to that. More specifically, processes similar to this exemplary embodiment can be performed by denoting the network state stored in the database unit 220 by “0” in the case of the communication quality of the mobile communication terminal 500 being favorable while denoting the network state by “1” in the case of the communication quality being poor, and then, putting “1” in the column of poor and “0” in the column of favorable when the retrieved network state is “1.”

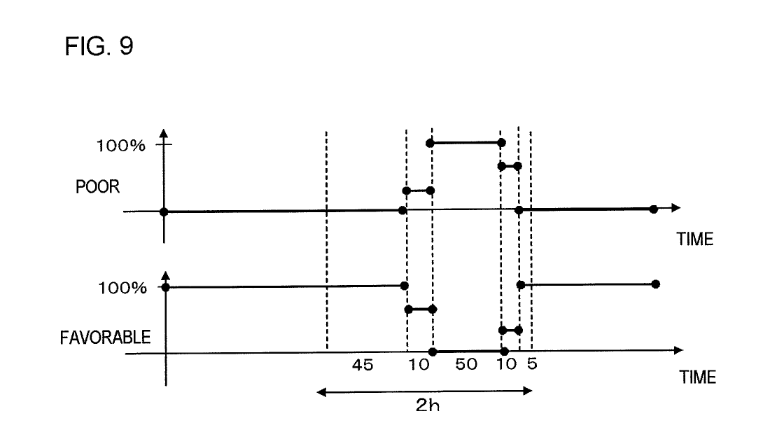

Further, the table in FIG. 8(E) indicates information in which plural pieces of the network prediction information are integrated, and represents the above-described prediction result. Note that the mode of the prediction result is not limited to the table as described above. It may be possible to employ a graph as illustrated in FIG. 9, or employ a function or data similar to the table in FIG. 8(E) or the graph in FIG. 9.

Next, processes of the reliability calculation unit 215 will be specifically described. The reliability calculation unit 215 calculates a reliability of the prediction result in a manner that: a larger value of a probability indicated by network prediction information generated by the prediction unit 213 and a value obtained by subtracting the probability from 1 is multiplied by a time indicated by time-period information corresponding to the network prediction information; the sum total of the values obtained by the multiplication is divided by the sum total of times indicated by time-period information used in the multiplication; a value obtained by this division is used as the reliability of the prediction result. The above-described calculation can be expressed by the following Equation (1).

$$\begin{matrix}[ Equation 1 ] & \\ α = \frac{{\sum }_{s ∈ S} Dur ( s ) \cdot ( {max}_{n ∈ Net} P ( s , n ) )}{{\sum }_{s ∈ S} Dur ( s )} & ( 1 )\end{matrix}$$

A set S in Equation (1) is a set formed by elements of the time-periods in table in FIG. 8. A function Dur is a function that uses a time period as an argument and outputs a duration time. A set Net is a set formed by elements of types of networks. A function P is a function that uses time periods and types of networks as arguments and outputs a probability of the network in the time period. The character a represents a reliability of the prediction result.

For example, in a state as illustrated in FIG. 8(E) or FIG. 9, the set S is formed by {“0 m-45 m,” “45 m-55 m,” “55 m-1 h45 m,” “1 h45 m-1 h55 m,” and “1 h55 m-2 h”}, and the set Net is formed by {“favorable,” and “poor”}. Further, calculation examples of the function Dur and the function P include Dur (“0 m-45 m”)=45, P(“0 m-45 m,” “favorable”)=1, P(“0 m-45 m,” “poor”)=0.

Therefore, the reliability in this exemplary embodiment is (45*1+10*0.67+50*1+10*0.67+5*1)/120=0.945.

In the case where the reliability is calculated using Equation 1, the calculated value is in the range of 0.5 to 1.0. Therefore, it is desirable that the threshold value in step S109 be set in the range of 0.5 to 1.0.

Next, effects of this exemplary embodiment will be described. In this exemplary embodiment, the network states expressed by numerals are collected to obtain an average value thereof and are normalized, whereby it is possible to generate the normalized value as the network prediction information. Therefore, the network prediction information can be obtained as a probability of the communication quality of the mobile communication terminal 500 being favorable, or a probability of that being poor.

Further, in this exemplary embodiment, the network prediction information is generated for each of the time periods defined on the basis of the time-period information, and hence, it is possible to precisely predict the communication quality of the mobile communication terminal 500.

The mobile communication terminal 500 can request the transmission-and-reception device 600 to transmit and receive the electronic data in a time period when the communication quality is favorable, more specifically, in a time period when the probability of the communication quality being favorable is higher than the threshold value, or when the probability of the communication quality being poor is lower. With this configuration, it is possible to prevent the transmission-and-reception errors of the electronic data due to deterioration in the communication quality, and to efficiently transmit and receive the electronic data between the mobile communication terminal 500 and the transmission-and-reception device 600.

Further, this exemplary embodiment retrieves the network state associated with the first time information and the second time information having a time interval substantially equal to an inputted time. Therefore, the network state prediction device 100 according to this exemplary embodiment generates the network information on the basis of the network state on a route having the same starting point, the same ending point and the same halfway point through which the mobile communication terminal 500 is estimated to pass using the same transportation, whereby it is possible to highly accurately predict the communication quality of the mobile communication terminal 500.

Yet further, this exemplary embodiment generates the prediction result by integrating the plural pieces of the network prediction information, whereby it is possible to predict the communication quality of the mobile communication terminal 500 throughout the entire route.

Yet further, this exemplary embodiment calculates the reliability of the prediction result, and outputs the prediction result in the case where the calculated reliability exceeds the threshold value, whereby it is possible to provide the external device, the user and the like with the highly reliable prediction result.

Yet further, in the case where the calculated reliability is less than the threshold value, this exemplary embodiment repeats prediction by limiting the first position information and the second position information to information indicating a narrower area. This makes it possible to set the retrieving condition in a multi-stage manner. More specifically, by performing the retrieval using the first position information and the second position information indicating wider areas, the reliability of the prediction result is more likely to decrease, although the probability of obtaining the network state from the database increases. On the other hand, by performing the retrieval using the first position information and the second position information indicating narrower areas, the reliability of the prediction result is more likely to increase, although the probability of obtaining the network state from the database decreases. As described above, each of these has advantages and disadvantages. Therefore, it is desirable that the retrieving condition can be set in a multi-stage manner as is the case with this exemplary embodiment.

### Third Exemplary Embodiment

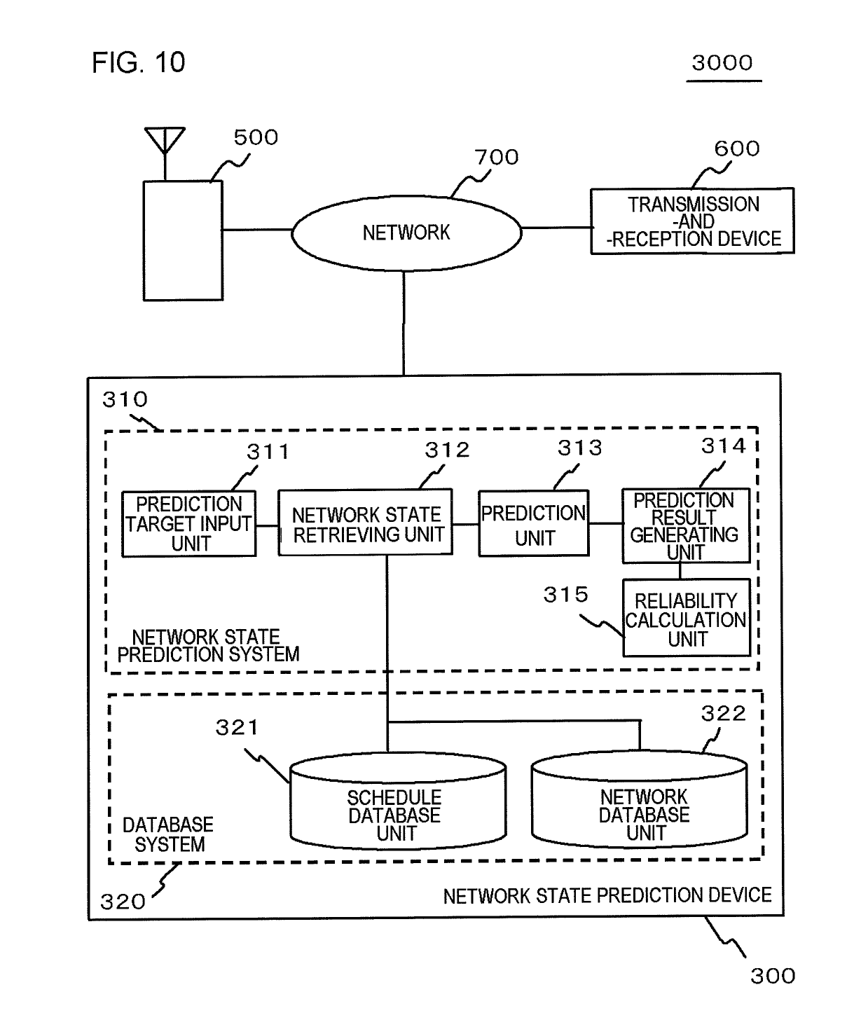

FIG. 10 is a configuration diagram illustrating a mobile communication system 3000 according to a third exemplary embodiment. The mobile communication system 3000 according to this exemplary embodiment includes a network state prediction device 300, a mobile communication terminal 500, a transmission-and-reception device 600, and a network 700. The mobile communication terminal 500, the transmission-and-reception device 600 and the network 700 are equivalent to those described in the first exemplary embodiment.

The network state prediction terminal 300 includes a configuration contained in a database system 320 and a configuration contained in a network state prediction system 310. The database system 320 includes a schedule database unit 321 and a network database unit 322.

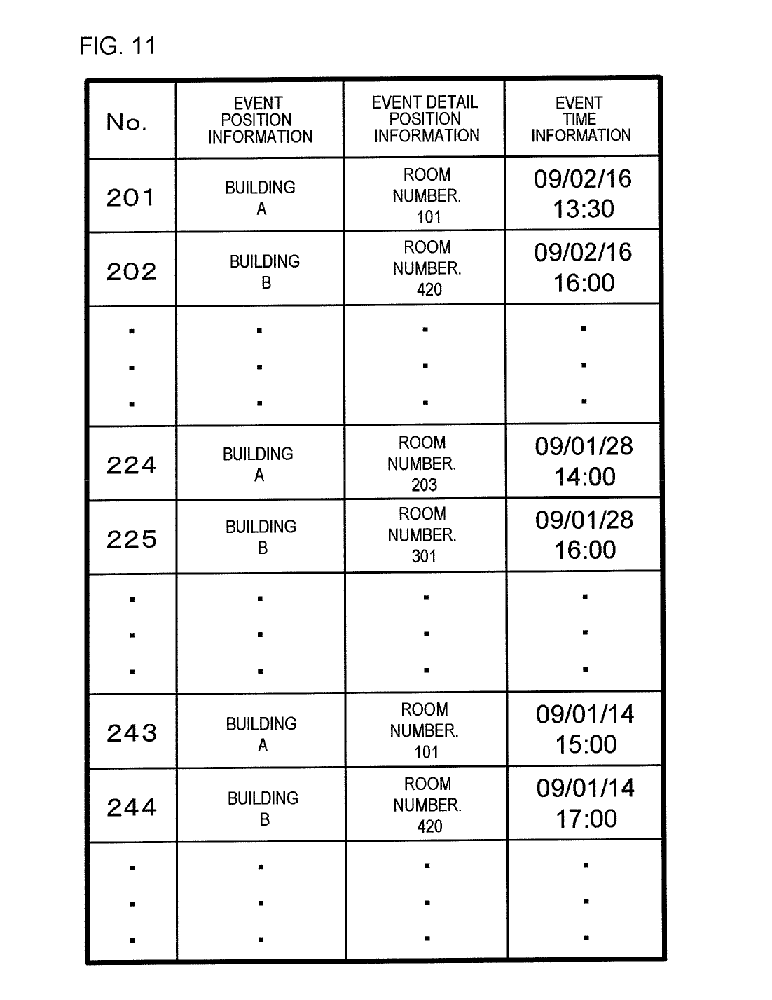

FIG. 11 is a diagram illustrating a part of a data table in the schedule database unit 321. The schedule database unit 321 stores event position information indicating a position of an event concerning a user who uses the mobile communication terminal 500, event detail position information indicating an area narrower than that indicated by the event position information, and event time information indicating a time of the event, in a manner that they are associated with each other.

The event position information and the event time information described above may be generated through operation input received from a keyboard, a touch panel and the like (not illustrated) that the mobile communication terminal 500 includes. Further, the event position information and the event time information described above may be generated by and obtained from a device (including the network state prediction device 200) other than the mobile communication terminal 500, and be stored in the schedule database unit 321.

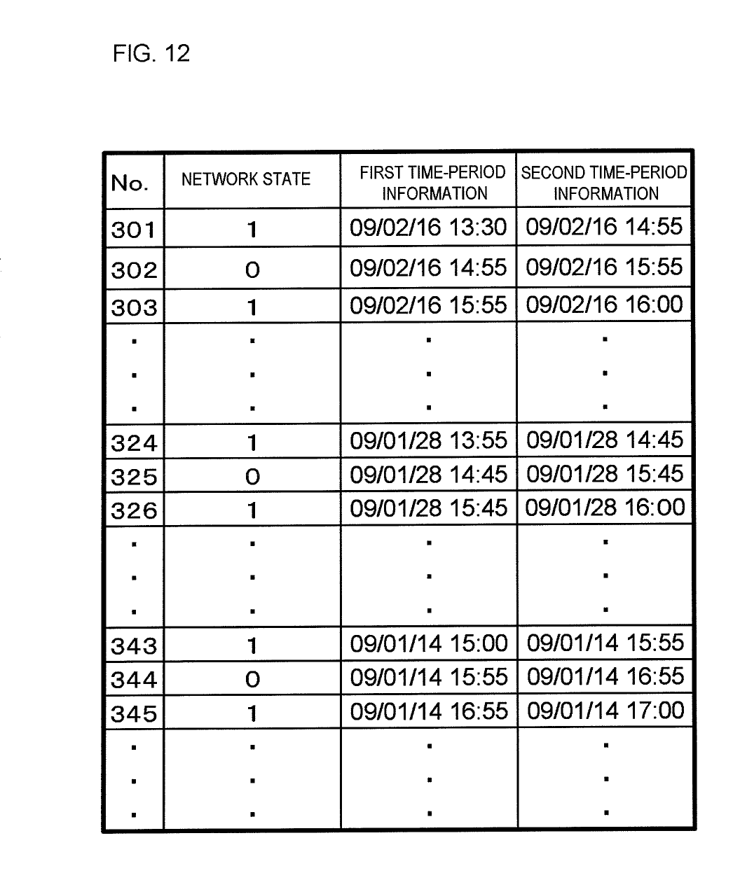

FIG. 12 is a diagram illustrating a part of a data table in the network database unit 322. The network database unit 322 stores time-period information indicating a certain time period, and a network state indicating a communication quality of the mobile communication terminal 500 in the certain time period in a manner that they are associated with each other. This data table stores first time-period information indicating a starting time in a certain time period, second time-period information indicating an ending time in the certain time period, a network state indicating the communication quality of the mobile communication terminal 500 in the certain time period in a manner that they are associated with each other.

Next, the configuration included in the network state prediction system 310 will be described. Since procedures are not significantly different between this exemplary embodiment and the third exemplary embodiment, the description will be made with reference to the flowchart in FIG. 7.

First, the network state prediction device 300 generates a database in the database system 320 (step S101). Details of step S101 have been already described, and hence, explanation thereof will not be repeated.

Similarly to the prediction target input unit 211 of the second exemplary embodiment, a prediction target input unit 311 is a unit for inputting the first position information and the second position information, and inputting the first time information, the second time information, the first detail position information, and the second detail position information (step S102).

Of all the event time information on the same date, a network state retrieving unit 312 retrieves, from the schedule database unit 321, first event time information associated with the event position information compared with and matching with the first position information inputted through the prediction target input unit 311, and second event time information associated with event position information compared with and matching with the second position information inputted through the prediction target input unit 311, and, then, associates the retrieved first event time information and the retrieved second event time information with each other (step S103).

Further, of pairs of the first event time information and the second event time information, the network state retrieving unit 312 retrieves, from the schedule database unit 321, such a pair of the first event time information and the second event time information that a difference between time T5 (actual time) extending from the first event time information to the second event time information and time T6 (prediction target time) extending from the first time information to the second time information inputted through the prediction target input unit 311 falls within a predetermined range (step S104).

The network state retrieving unit 312 retrieves, from the network database unit 322, a network state associated with time-period information indicating a time between the first event time information and the second event time information constituting the pair retrieved from the schedule database unit 321 (step S105).

Processes of a prediction unit 313, a prediction result generating unit 314, and a reliability calculation unit 315 (step S106 to step S111) are similar to those of the prediction unit 213, the prediction result generating unit 214, and the reliability calculation unit 215 in the second exemplary embodiment, and hence, explanation thereof will not be repeated.

Next, effects of this exemplary embodiment will be described. In this exemplary embodiment, the network prediction information and the prediction result can be generated using two different databases (schedule database unit 321 and network database unit 322). In other words, the present invention can be realized by utilizing the databases and the like generated by the widely used scheduler and network management functions.

The exemplary embodiments according to the present invention have been described with reference to the drawings. These are merely examples of the present invention, and it may be possible to employ various configurations other than those described above.

In FIG. 3, there is only one type of network state associated with the first position information and the second position information. However, for example, it may be possible to employ two types of network states associated with the first position information and the second position information in the case of obtaining an uplink speed and a downlink speed of the line to which the mobile communication terminal 500 connects.

In the exemplary embodiments described above, the network state is set to the line speed of the line to which the mobile communication terminal 500 connects. However, the network state is not limited to that. For example, the network state may be a type of a line to which the mobile communication terminal 500 connects, or may be the radio intensity of wireless signals received through the line. Further, the network state may be information formed by combining two or more of the line speed, the type of line, and the radio intensity of wireless signals. More specifically, the network state may be information such as “802.11b, *** Mbps” and “mobile network HSDPA, **mV/m.” At this time, the generated network prediction information may be an average line speed of a line to which the mobile communication terminal 500 connects on a target route, or may be a probability of a line type, or may be an average value of the radio intensity, or may be information obtained by combining two or more thereof.

Further, in the exemplary embodiments described above, the descriptions have been made on the assumption that the network prediction information can be divided into two types of states: favorable and poor. However, the network prediction state may be divided into three or more types. In this case, the mobile communication terminal 500 may request transmission-and-reception of electronic data at the time when the received network prediction information indicates the most favorable state. Alternatively, the mobile communication terminal 500 may request transmission-and-reception of the electronic data at the time when the received network prediction information indicates states other the poorest state.

Further, in the exemplary embodiments described above, the descriptions have been made on the assumption that there is only one mobile communication terminal 500. However, there may be two or more mobile communication terminals 500. In this case, the data table stored in the database may be separated for each of the mobile communication terminals. In the case where these mobile communication terminals have the same functions, these mobile communication terminals may share the data table stored in the database with each other.

Further, in the exemplary embodiments described above, the connection between the mobile communication terminal 500 and the network state prediction device 100, 200, 300 is made through the network 700. However, the connection is not limited to that. For example, the mobile communication terminal 500 and the network state prediction device 100, 200, 300 may be connected directly to each other, or the mobile communication terminal 500 may include a part or whole of the configuration of the network state prediction device 100, 200, 300.

Further, in the second exemplary embodiment, the descriptions have been made such that, when the first position information and the second position information are inputted, the network prediction information is generated in accordance with the time series from the first time-period information to the second time-period information stored in the database unit 220. However, the generation of the network prediction information is not limited to that. For example, when the user inputs a route from Building A to Building B, the first position information=Building B and the second position information=Building A are inputted through the prediction target input unit 211. The network state retrieved on the basis of that input has the inversed order as compared with the route that the user requests. Therefore, the network state is inputted into the table illustrated in FIG. 8 in a manner that the order of the time series from the first time-period information to the second time-period information in the data table is reversed. This makes it possible to generate the network prediction information using the network state on a route the reverse of the route that the user inputs.

Further, in the second exemplary embodiment, the prediction unit 213 makes up the network prediction information on the assumption that the retrieved network states have the same worth. However, when collecting the network states retrieved by the network state retrieving unit 212, the prediction unit 213 may assign weights to the respective network states. For example, in the case where prediction is performed by placing the emphasis on the most recent network state, the following method may be employed.

The prediction unit 213 may perform the prediction by using N pieces of the most recently obtained network states or the network states of N days from the most recently obtained network state of all the network states retrieved through the network state retrieving unit 212. Further, although FIG. 8 illustrates that a value of one network state is incremented by one, the value of the one network state is incremented by a value of a weighting function exp(−(t²)/(tau²)). The variable t is a parameter representing how many days have elapsed before the day when this information was retrieved by the network state retrieving unit 212. Further, the variable tau is a parameter indicating how long the information is considered to be reliable from the time when the information is available. Further, the above-described weighting function is merely an example. As another example, by using the weighting function (1/x²), where x is the number of days from the current point in time, the amount of weight similarly decreases as time passes from the latest one.

Further, in addition to the retrieving conditions for network state retrieving unit 112 (212, 312) described in the exemplary embodiments above, the prediction accuracy may be improved by using the following retrieving conditions. It may be possible to use any one of the following retrieving conditions, or to use two or more of the following conditions:

network states associated with first time information or second time information indicating the morning (afternoon) in the case where the inputted first time information or the inputted second time information indicates the morning (afternoon);

network states associated with first time information and second time information matching with any of the following three cases: first time information indicative of morning and second time information indicative of morning; first time information indicative of morning and second time information indicative of afternoon; first time information indicative of afternoon and second time information indicative of afternoon, these three cases being treated as different cases;

network state satisfying that a difference between associated first time information and inputted first time information falls within a predetermined range;

network state satisfying that a difference between associated second time information and inputted second time information falls within a predetermined range;

network state under which associated first time information is earlier than a predetermined time period;
network state under which associated second time information is later than a time period; and

network state under which the above-described time period is a break-time (usage of a network by a user is different between moving without rest and moving with rest).

Further, in the second exemplary embodiment or third exemplary embodiment, the descriptions have been made such that the database unit 220 or the network database unit 322 store the time-period information and the network state in a manner that they are associated with each other. However, these exemplary embodiments are not limited to that. For example, it may be possible to store section information indicating a section on a route on which the mobile communication terminal 500 moves and a network state indicating a communication quality of the mobile communication terminal in the section in a manner that they are associated with each other. In this case, for each section divided on the basis of the section information, the prediction unit 213 can generate the network prediction information indicating at least one of the communication quality being favorable and the communication quality being poor. At this time, the mobile communication terminal 500 may request the transmission-and-reception device 600 to transmit and receive electronic data in a section where the network prediction state is favorable.

More specifically, the prediction unit 213 may generate at least one of a probability of the communication quality being favorable and a probability of the communication quality being poor as the network prediction information. Then, the mobile communication terminal 500 may request the transmission-and-reception device 600 to transmit and receive the electronic data in a section where the probability of the communication quality being favorable exceeds a predetermined threshold value, or a section where the probability of the communication quality being poor is less than the predetermined threshold value.

In this case, the reliability calculation unit 215 may calculate the reliability of the prediction result such that: a larger value of a probability indicated by the network prediction information generated by the prediction unit 213 and a value obtained by subtracting this probability from one is multiplied by a distance indicated by the section information corresponding to the network prediction information; the sum total of values obtained through the multiplication is divided by the sum total of distances indicated by the section information used in the multiplication above; and, a value thus obtained through the division is used as the reliability of the prediction result.

Further, in the third exemplary embodiment, the descriptions have been made such that the network state is retrieved by referring to the data tables explained with reference to FIG. 11 and FIG. 12. However, it may be possible to generate the data table in FIG. 6 by previously combining the tables illustrated in FIG. 11 and FIG. 12, and it may be possible to employ the thus generated data table.

Further, in the third exemplary embodiment, the descriptions have been made on the assumption that the data table is generated by the scheduler function. However, it may be possible to realize the present invention by utilizing a positioning system such as GPS.

More specifically, the database system 320 includes a positioning database unit that stores positioning information generated by measuring the position of the mobile communication terminal 500, and a positioning time information indicating a time when the positioning information is generated in a manner that they are associated with each other, and the network database unit 322 that stores the time-period information and the network state in a manner that they are associated with each other. Of all the positioning time information on the same date, the network state retrieving unit 312 may retrieve, from the positioning database unit, first positioning time information associated with measured-position information matching with the first position information inputted through the prediction target input unit 311, and second positioning time information associated with measured-position information matching with the second position information inputted through the prediction target input unit 311, in a manner that the first positioning time information and the second positioning time information are correlated with each other. Further, it may be possible to retrieve, from the network database unit 322, the network state associated with the time-period information indicating a time between the first positioning time information and the second positioning time information retrieved as described above.

In the second exemplary embodiment, the position information stored in the data table in the database unit 220 and the position information inputted through the prediction target input unit 211 are position information with two steps such as Building A-Room No. 101 and Building B-Room No. 301. Therefore, in step S111 in FIG. 7, determination “YES” can be made only one time, and the process from step S103 to step S109 is repeated only one time. In this respect, by increasing layers of the position information such as oo office-Building oo-Room No. oo, and oo City-oo Word-oo Town-oo Chome, it is possible to increase the number of times that the determination “YES” is possible in step S111. In the case where the position information with N layers is inputted through the prediction target input unit 211, and the position information with N layers, where N is a positive integer, is stored in the data table in the database unit 220, it is possible to repeat the process from step S103 to step S109 up to (N-1) times.

In FIG. 11, only one type of the event time information is set. However, it may be possible to set two types of event time information including event time information indicating an event-starting time and event time information indicating an event-ending time, or may be possible to set three or more types of even time information.

Further, the above-described exemplary embodiments exemplify that respective units of a data processing device are logically realized as various functions by a computer program. However, each of these units may be formed independently by hardware, or may be realized by a combination of software and hardware.

It should be noted that, naturally, the above-described exemplary embodiments and plural modification examples can be combined, provided that contents thereof do not contradict each other. Further, in the above-described exemplary embodiments and modification examples thereof, functions of the constituting elements have been specifically described. These functions may be changed within the scope that satisfies the present invention.

Further, in the method for predicting the network state according to the present invention, plural steps are specified in a sequential order. However, this specification of the order does not limit the order in which the plural steps are performed. Therefore, at the time of performing the method for predicting the network state according to the present invention, the order of the plural steps may be changed, provided that such a change does not impair the contents thereof.

The present application claims priority based on Japanese Patent Application No. 2009-172118 filed in Japan on Jul. 23, 2009, all of which disclosure is incorporated herein by reference.

1. A network state prediction device comprising:
a database unit that stores first position information indicative of an end position on one side of a route on which a mobile communication terminal moves, second position information indicative of an end position on the other side of the route, and a network state indicative of a communication quality of a line to which the mobile communication terminal communicatively connects on the route, in a manner that the first position information, the second position information, and the network state are associated with each other;
a prediction target input unit adapted to input first input position information indicative of an end position on one side of a target route serving as a route to be predicted, and second input position information indicative of an end position on the other side of the target route;
a network state retrieving unit that retrieve from the database unit the network state on the basis of the first input position information and the second input position information, both of which are inputted through the prediction target input unit, and the first position information and the second position information, both of which are stored in the database unit; and
a prediction unit that generates network prediction information concerning the communication quality at the time when the mobile communication terminal moves on the target route on the basis of the network state retrieved by the network state retrieving unit.

2. The network state prediction device according to claim 1, wherein
the database unit stores time-period information indicative of a time period and the network state indicative of the communication quality of the mobile communication terminal in the time period in a manner that the time-period information and the network state are associated with each other, or stores section information indicative of a section on the route and the network state indicative of the communication quality of the mobile communication terminal in the section in a manner that the section information and the network state are associated with each other, and
the prediction unit generates the network prediction information indicative of at least one of the communication quality being favorable and the communication quality being poor, for each time period divided on the basis of the time-period information or for each section divided on the basis of the section information.

3. The network state prediction device according to claim 2, wherein the prediction unit generates, as the network prediction information, at least one of a probability of the communication quality being favorable and a probability of the communication quality being poor.

4. The network state prediction device according to claim 3, wherein
the database unit stores the network state expressed by a numeric value, and
the prediction unit collects the network state retrieved by the network state retrieving unit, and generates, as the network prediction information, a value obtained by normalizing the collected network state.

5. The network state prediction device according to claim 4, wherein the prediction unit collects the network state retrieved by the network state retrieving unit while weighting the network state.

6. The network state prediction device according to claim 2, further comprises a prediction result generating unit that generates a prediction result in which a plurality of the network prediction information generated by the prediction unit are integrated.

7. The network state prediction device according to claim 6, further comprising a reliability calculation unit that calculates a reliability of the prediction result generated by the prediction result generating unit,
wherein the prediction result generating unit outputs the prediction result in the case where the reliability calculated by the reliability calculation unit exceeds a predetermined threshold value.

8. The network state prediction device according to claim 7, wherein the reliability calculation unit multiplies a larger value of a probability indicated by the network prediction information generated by the prediction unit and a value obtained by subtracting the probability from 1 by a time indicated by the time-period information corresponding to the network prediction information, divides a sum total of a value obtained by the multiplication by a sum total of a time indicated by the time-period information used in the multiplication, and obtains, as the reliability of the prediction result, a value obtained by the division.

9. The network state prediction device according to claim 7, wherein the reliability calculation unit multiplies a larger value of a probability indicated by the network prediction information generated by the prediction unit and a value obtained by subtracting the probability from 1 by a distance indicated by the section information corresponding to the network prediction information, divides a sum total of a value obtained by the multiplication by a sum total of a distance indicated by the section information used in the multiplication, and obtains, as a reliability of the prediction result, a value obtained by the division.

10. The network state prediction device according to claim 1, wherein
the database unit stores first detail position information indicative of an area narrower than the area indicated by the first position information, second detail position information indicative of an area narrower than the area indicated by the second position information, and the network state in a manner that the first detail position information, the second detail position information, and the network state are associated with each other,
the prediction target input unit is adapted to input first detail input position information indicative of an area narrower than the area indicated by the first input position information and second detail input position information indicative of an area narrower than the area indicated by the second input position information, and
the network state retrieving unit retrieves the network state from the database unit on the basis of the first detail input position information and the second detail input position information inputted through the prediction target input unit in the case where the reliability calculated by the reliability calculation unit is less than the threshold value.

11. The network state prediction device according to claim 1, wherein
the database unit stores first time information indicative of a time corresponding to the first position information and second time information indicative of a time corresponding to the second position information in a manner that the first time information and the second time information are associated with the network state,
the prediction target input unit is adapted to input first input time information indicative of a time corresponding to the first position information and second input time information indicative of a time corresponding to the second position information, and
the network state retrieving unit retrieves the network state in the case where a difference between an actual time extending from the first time information to the second time information, both of which are associated with the network state, and a prediction target time extending from the first input time information to the second input time information inputted through the prediction target input unit falls within a predetermined range.

12. The network state prediction device according to claim 11, wherein the network state retrieving unit retrieves the network state in the case where a difference between the first time information associated with the network state and the first input time information inputted through the prediction target input unit falls within a predetermined range, or in the case where a difference between the second time information associated with the network state and the second input time information inputted through the prediction target input unit falls within a predetermined range.

13. The network state prediction device according to claim 10, wherein the network state retrieving unit retrieves the network state in the case where the first time information associated with the network state is earlier than a predetermined time period, or in the case where the second time information associated with the network state is later than the time period.

14. The network state prediction device according to claim 1, wherein
the database unit comprises: a schedule database unit that stores event position information indicative of a place of an event in connection with a user who uses the mobile communication terminal, and event time information indicative of a time of the event in a manner that the event position information and the event time information are associated with each other; and a network database unit that stores the time-period information and the network state so as to be associated with each other, and
the network state retrieving unit retrieves, from the schedule database unit, first event time information and second event time information from among the event time information on the same date, the first event time information associated with the event position information compared with and matching with the first position information inputted through the prediction target input unit, the second event time information associated with the event position information compared with and matching with the second position information inputted through the prediction target input unit, associates the first event time information with the second event time information, and retrieves, from the network database unit, the network state associated with the time-period information indicative of a time between the first event time information and the second event time information associated with each other.

15. The network state prediction device according to claim 1, wherein
the database unit comprises: a positioning database unit that stores positioning information generated by measuring a position of the mobile communication terminal, and positioning time information indicative of a time when the positioning information is generated, in a manner that the positioning information and the positioning time information are associated with each other; and a network database unit that stores the time-period information and the network state so as to be associated with each other, and
the network state retrieving unit retrieves, from the positioning database unit, first positioning time information and second positioning time information from among the positioning time information on the same date, the first positioning time information associated with the positioning information compared with and matching with the first position information inputted through the prediction target input unit, the second positioning time associated with the positioning information compared with and matching with the second position information inputted through the prediction target input unit, associates the first positioning time information with the second positioning time information, and retrieves, from the network database unit, the network state associated with the time-period information indicative of a time between the first positioning time information and the second positioning time information associated with each other.

16. A mobile communication system comprising:
a mobile communication terminal;
a transmission-and-reception device that transmits and receives electronic data in response to a request received from the mobile communication terminal; and
a network state prediction device that outputs, to the mobile communication terminal, network prediction information concerning a communication quality at the time when the mobile communication terminal moves on a target route which is a route to be predicted,
said network state prediction device including:
a database unit that stores first position information indicative of an end position on one side of a route on which the mobile communication terminal moves, second position information indicative of an end position on the other side of the route, and a network state indicative of the communication quality of a line to which the mobile communication terminal communicatively connects on the route, in a manner that the first position information, the second position information, and the network state are associated with each other;
a prediction target input unit adapted to input first input position information indicative of an end position on one side of the target route, and second input position information indicative of an end position of the other side of the target route;
a network state retrieving unit that retrieves the network state from the database unit on the basis of the first input position information and the second input position information, both of which are inputted through the prediction target input unit, and the first position information and the second position information, both of which are stored in the database unit; and
a prediction unit that generates the network prediction information on the basis of the network state retrieved by the network state retrieving unit, and
said mobile communication terminal requesting the transmission-and-reception device to transmit and receive the electronic data on the basis of the network prediction information received from the network state prediction device.

17. The mobile communication system according to claim 16, wherein
the database unit stores time-period information indicative of a time period, and the network state indicative of the communication quality of the mobile communication terminal in the time period in a manner that the time-period information and the network state are associated with each other,
the prediction unit generates the network prediction information indicative of at least one of the communication quality being favorable and the communication quality being poor, for each time period divided on the basis of the time-period information, and
the mobile communication terminal requests the transmission-and-reception device to transmit and receive the electronic data in a time period in which the network state is favorable.

18. The mobile communication system according to claim 17, wherein
the prediction unit generates at least one of a probability of the communication quality being favorable and a probability of the communication quality being poor, as the network prediction information, and
the mobile communication terminal requests the transmission-and-reception device to transmit and receive the electronic data in a time period in which the probability of the communication quality being favorable exceeds a predetermined threshold value, or in a time period in which the probability of the communication quality being poor is less than a predetermined threshold value.

19. The mobile communication system according to claim 16, wherein
the database unit stores section information indicative of a section on the route, and the network state indicative of the communication quality of the mobile communication terminal in the section in a manner that the section information and the network state are associated with each other,
the prediction unit generates the network prediction information indicative of at least one of the communication quality being favorable and the communication quality being poor for each section divided on the basis of the section information, and
the mobile communication terminal requests the transmission-and-reception device to transmit and receive the electronic data in a section in which the network prediction state is favorable.

20. The mobile communication system according to claim 19, wherein
the prediction unit generates at least one of a probability of the communication quality being favorable and a probability of the communication quality being poor, as the network prediction information, and
the mobile communication terminal requests the transmission-and-reception device to transmit and receive the electronic data in a section in which the probability of the communication quality being favorable exceeds a predetermined threshold value, or in a section in which the probability of the communication quality being poor is less than a predetermined threshold value.

21. The mobile communication system according to claim 17, wherein
said network state prediction device includes:
a prediction result generating unit that generates a prediction result in which a plurality of the network prediction information generated by the prediction unit are integrated; and
a reliability calculation unit that calculates a reliability of the prediction result generated by the prediction result generating unit, and
outputs the prediction result to the mobile communication terminal in the case where the reliability calculated by the reliability calculation unit exceeds a predetermined threshold value, and
said mobile communication terminal requests the transmission-and-reception device to transmit and receive the electronic data on the basis of the network prediction information contained in the prediction result.

22. A mobile communication method including:
generating step of generating a database by storing first position information indicative of an end position on one side of a route on which a mobile communication terminal moves, second position information indicative of an end position on the other side of the route, and a network state indicative of a communication quality of a line to which the mobile communication terminal communicatively connects on the route, in a manner that the first position information, the second position information, and the network state are associated with each other;
inputting first input position information indicative of an end position on one side of a target route, which is a route to be predicted, and second input position information indicative of an end position on the other side of the target route;
retrieving the network state from the database on the basis of the inputted first input position information and the inputted second input position information and the first position information and the second position information, both of which are stored in the database;
generating network prediction information concerning the communication quality at the time when the mobile communication terminal moves on the target route on the basis of the retrieved network state; and
making a request, by the mobile communication terminal, to transmit and receive electronic data on the basis of the generated network prediction information.

23. A storage medium storing a program that causes a network state prediction device to execute data processing, the data processing including:
a database generating process of generating a database by storing first position information indicative of an end position on one side of a route on which a mobile communication terminal moves, second position information indicative of an end position on the other side of the route, and a network state indicative of a communication quality of a line to which the mobile communication terminal communicatively connects on the route, in a manner that the first position information, the second position information, and the network state are associated with each other;
a prediction target input process of inputting first input position information indicative of an end position on one side of a target route, which is a route to be predicted, and second input position information indicative of an end position on the other side of the target route;
a network state retrieving process of retrieving the network state from the database on the basis of the first input position information and the second input position information, both of which are inputted in the prediction target input process, and the first position information and the second position information, both of which are stored in the database; and
a prediction process of generating network prediction information concerning the communication quality at the time when the mobile communication terminal moves on the target route on the basis of the network state retrieved in the network state retrieving process.
